(19) United States
(12) Patent Application Publication
(10) Pub. No.: US 2009/0210267 A1
(43) Pub. Date: Aug. 20, 2009

(54) SYSTEM AND METHOD FOR AUTOMATICALLY MAPPING SECURITY CONTROLS TO SUBJECTS

(76) Inventors: Bryan David Fish, Dallas, TX (US); Stephen Matthew Brewer, Dallas, TX (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/032,900

(22) Filed: Feb. 18, 2008

(51) Int. Cl. G06Q 99/00

(52) U.S. Cl. 705/7

(57) ABSTRACT

A computer system and method is disclosed for automatically and dynamically mapping risk management controls to risk management profiles based upon criteria associated with each control and values associated with each risk management profile. A database is populated with a plurality of risk management controls which may correspond to the commandments of a security requirement. The database is also populated with a plurality of risk management profiles and associated attribute values which represent information technology subjects within an organization. A computer process maps each individual risk management control to the appropriate profiles so that the organization may properly execute the control on the associated subject. Alternatively, a set of risk management profiles may be automatically determined based upon the risk management profiles and a plurality of commandments associated with a security reference.

### FIELD OF THE INVENTION

The present invention generally relates to the field of enterprise and information security as well as methods for establishing the same. More particularly, but not exclusively, the present invention pertains to a system and method for dynamically mapping a plurality of security controls to a subject.

### BACKGROUND

With the development and use of the first computer came the need for computer security. Early on, computer security was likely to be a mere access limitation, such as a lock on the door to the no doubt large room in which it was housed. This security was likely put in place due to the expense of the computer's hardware more than anything. As the use of computers in the corporate and government environment has shown remarkable growth in the past twenty years, so too has the value and confidentiality of the information which they maintain. Due to this rise in the wealth of information maintained by corporate computer networks and storage environments security has risen from a simple locked door to software user access restrictions, encrypted transmissions, complex password requirements, and many others. As a result, in order to exist in the digital world, organizations must often construct, implement, and maintain their compliance with a robust security policy or security reference in order to protect the information generated by and/or entrusted to them.

In order to ensure consumer protection, many entities, such as payment processors and the Federal government, have mandated compliance with minimum, albeit complicated, security references for many organizations. For instance, the Payment Card Industry Data Security Standard (PCI) was developed by the major credit card companies, such as Visa and Mastercard, as a guideline to help organizations that process card payments prevent credit card fraud, hacking and various other security vulnerabilities and threats. In order to maintain their ability to process credit card payments, any company processing, storing, or transmitting large volumes of payment card data must be PCI compliant and submit reports evidencing their compliance periodically. Penalties for failing to comply range from being audited and/or fined to an outright loss of privileges. Other well-known security references include the Sarbanes-Oxley Act, the Gramm Leach Bliley Act, the Health Insurance Portability and Accountability Act (HIPAA), the standards sets forth by the National Institute of Standards and Technology (NIST), ISO 17799, ISO 27001, ISO 27002, and the Control Objectives for Information and Related Technology (COBIT). When a single organization is faced with implementing their own security policy and complying with one or more of these pro forma policies, the combination of individual requirements set forth by the combined security policies can be overwhelming, burdensome, and confusing.

In order to combat this problem, various compliance management software packages have evolved which allow information technology personnel and security consultants to compile a list of security controls which correspond to individual requirements of one or more security policy or reference. For instance, a security control may require workstations to employ strong password protection, server rooms to have physical employee access restriction, or externally accessible applications to require encrypted communications. However, the major drawback of these packages is that for each subject, or information technology asset, a conscious decision has to be made whether or not each individual control should be applied. Oftentimes, large organizations may possess and maintain thousands of subjects, such as information technology (IT) assets, and require the application of hundreds of controls to meet all of the applicable security policies. As such, the number of individual decisions which must be made, and made accurately, regarding the applicability of a control to an individual subject can easily become a monumental task requiring specialized skills in information security. When combined with the facts that new subjects are frequently added and standardized security polices are constantly in flux, the chore becomes akin to bailing water from a sinking ship. As such, improvements are needed in the way in which decisions are made regarding the applicability of a specified control to a selected subject within the context of a compliance management software package.

### SUMMARY

In a first embodiment of a method for mapping security controls to subjects, the method includes maintaining a plurality of controls in an electronic database, associating criteria with each of the individual controls; establishing a profile representing a subject within the electronic database, and automatically mapping a control to the profile based upon the criteria and the attributes of the subject associated with the profile.

In a second embodiment, a method includes maintaining a plurality of security commandments associated with a selected security reference in an electronic database, associating criteria with each of the individual commandments; establishing a number of profiles representing unique subjects within the electronic database, and automatically selecting a set of profiles which are in-scope for a commandment based upon the criteria and the attributes of the subjects associated with the profiles.

### BRIEF DESCRIPTION OF THE DRAWINGS

FIG. 1 is a diagrammatic view of a computer system suitable for use with one embodiment.

FIG. 2 is a flowchart illustrating one set of the steps performed in dynamically mapping controls to subjects according to one embodiment of the present invention.

FIG. 3 is a plan view of a representative risk management control according to the preferred embodiment of the present invention.

FIG. 4 is a plan view of a representative risk management profile according to the preferred embodiment of the present invention.

FIG. 5 is flowchart illustrating one set of the steps performed to automatically determine a set of subjects that are in scope for the commandments of a selected security reference according to a second embodiment of the present invention.

### DESCRIPTION OF THE SPECIFIC EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Disclosed is a method for dynamically mapping risk management controls to risk management profiles which represent IT assets within an organization using at least one criterion associated with each control and at least one value associated with an attribute of each subject. Thus, by providing initial information in a structured form, standardized controls may be mapped without the costly decision making process and further may be automatically adjusted for policy modifications or the addition and/or reorganization of assets. The process begins with a number of risk management controls being populated within an electronic database. A number of risk management profiles are then established, preferably for each subject, which includes a number of values defining the attributes of the subject. The process then dynamically maps the individual controls to the profiles based upon the information stored therein. Each control may be a textual representation of a security requirement which, once mapped, should be executed by the IT personnel of the organization or a security consultant. The actual implementation of a control may be by way of the execution of a selected piece of technology, such as a vulnerability scanner, etc.

Additionally, a method for automatically determining a set of profiles which represent subjects that are in-scope for each individual commandment of a security reference is provided. As such, the process of auditing and compliance report generation for a number of security references can be made much more efficient and accurate. The process begins with one or more security references having individual security commandments being established within an electronic database. Based upon the criteria associated with each commandment, the set of individual subjects to which they should apply can quickly be determined based upon the values of the attributes associated with their respective risk management profile. These sets may then be utilized during compliance auditing and reporting without being overly inclusive of out-of-scope subjects which may not warrant auditing or may be reported needlessly as non-compliant.

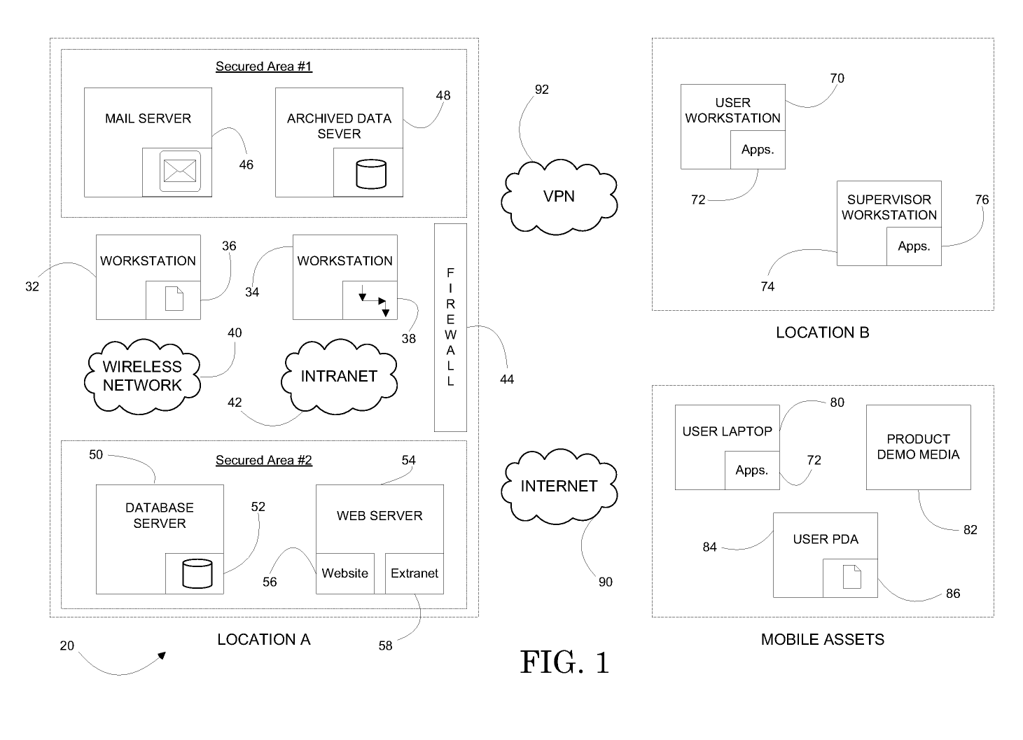

Turning to FIG. 1, a diagrammatic view of an information technology infrastructure is shown reflecting the implementation at least partially resulting from the use of one embodiment of the present invention. It shall be appreciated that the illustrated infrastructure is simplistic in comparison to that maintained by most organizations, but that only one of each type of a small variety of assets has been illustrated to preserve clarity while facilitating a description of the invention. IT infrastructure 20 includes two physical locations, denoted Location A and Location B. Location A and Location B may be located at geographically distinct locations or may be distinguished by one of a variety of other characteristics such as, but not limited to, different building of a corporate campus, different floors of an office building or different rooms of an office. Additionally, a Mobile Assets classification has been defined in order to categorize the various assets which are mobile and subject to various environments. In the illustrated infrastructure, Location A is the corporate headquarters of a large corporation, and Location B is a satellite office located in a different city. Location A includes workstation 32 and workstation 34, which may be client computers utilized by users such as corporate executives, secretaries, and support staff. For purposes of illustration, workstation 32 has access to documents 36 and workstation 34 has access to processes 38. Location A also includes wireless network 40, corporate intranet 42, and firewall 44. Additionally, location A includes two secured rooms, designated Secured Area 1 and Secured Area 2. Secured Area 1 houses Mail Server 46 and Archived Data Server 48. Secured Area 2 houses Database Server 50 which maintains database 52 and Web Server 54 which hosts the corporate website 56 and extranet 58.

Turning to Location B, the satellite office includes two user workstations, such as for use by a sales force and supervisor. User workstation 70 which provides access to a first application 72 and supervisor workstation 74 which provides access to a second, perhaps more sensitive, application 76. Finally, the Mobile Assets of the infrastructure 20 include user laptop 80 which has access to the first application 72, product demo media 82, such as CDs, DVDs, or flash memory modules, and user PDA 84 which stores documents 86. Finally, infrastructure 20 includes a connection to the Internet 90 in addition to a Virtual Private Network (VPN) 92.

The process for establishing representations of the IT assets and risk management controls within a software package will now be described. It shall be appreciated that a subject is something that can have controls applied to it, and can be evaluated to determine if that control has been implemented. For purposes of non-limiting example, a subject may be an application, a database, a network, a server, a workstation, a facility, a business process, or a user. Additionally, a control shall be understood to be some act done by an organization to protect a subject. A control may be administrative, technical, or physical in nature. Several non-limiting examples of controls include password requirements, encryption, door locks, background checks, and document destruction procedures.

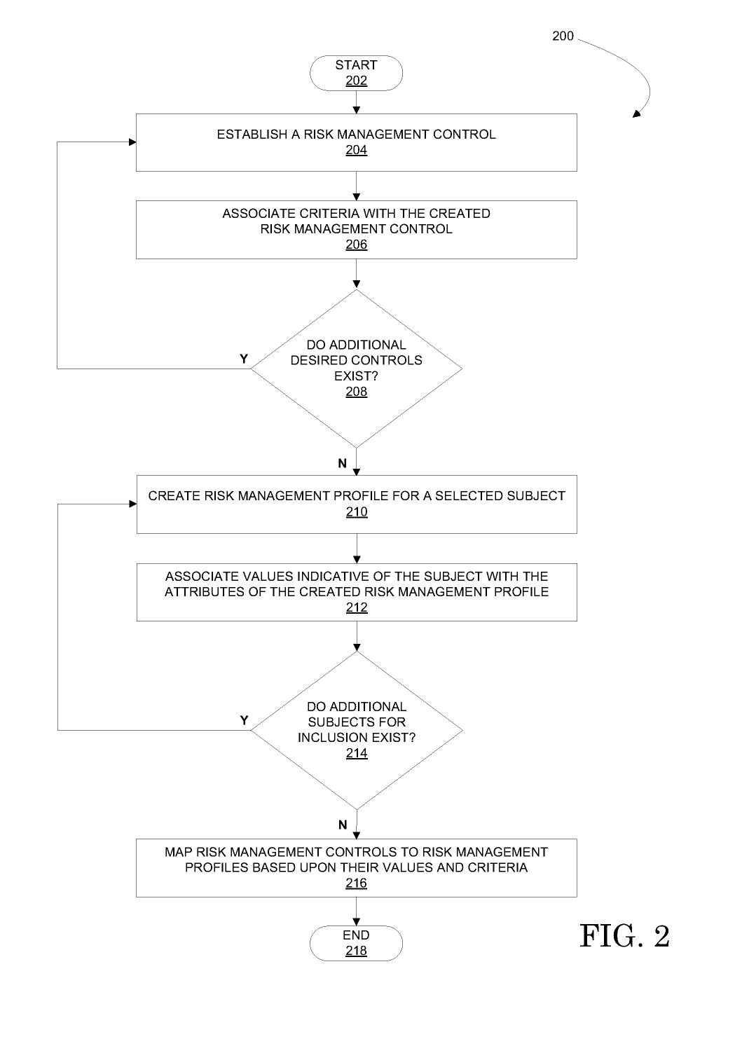

FIG. 2 is a flowchart illustrating one set of the steps performed in dynamically mapping controls to subjects. Process 200 begins at start point 202 with the organization establishing a risk management control (stage 204). A risk management control is a software representation of a control, which may be created within a software package and stored within an electronic database. Once created, the organization populates the risk management control with at least one criterion. It shall be appreciated that the acts described herein as taken by the organization may in fact be taken by the personnel of an organization or an outside consultant, but are imparted to the organization for clarity.

In the preferred embodiment, the at least one criterion may be the form of a boolean expression which evaluates to TRUE or FALSE when executed upon the values associated with the attributes of a risk management profile, described below. In a further form, the at least one criterion may be a boolean expression comprised of a number of boolean statements conjoined by boolean operators. In a further preferred form, the boolean expression is comprised of a plurality of criteria which each operate on various values in order to define the applicability of the associated control. Once the criteria have been associated with the risk management control in stage 206, a decision is made whether or not more desired controls exist for inclusion (stage 208). If additional controls exist, the process returns to stage 204 and iterates until all of the desired controls have been defined. Once completed, the process proceeds to stage 210.

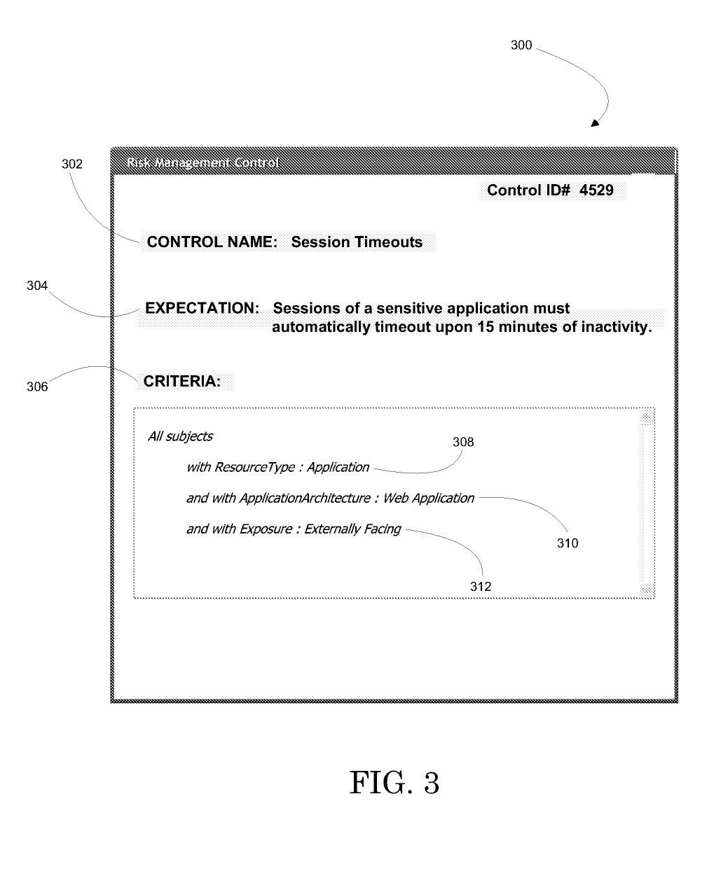

Turning briefly to FIG. 3, a plan view of a representative risk management control is illustrated according to the preferred embodiment of the present invention. Risk management control 300 includes a name field 302 for storing the name of the control represented and an expectation text block 304 for a brief description of the goal of the control and its method for implementation. The criteria field 306 includes a boolean expression which comprises a set of individual boolean criteria. In this example, field 306 includes criteria 308, 310, and 312 which define that the session timeouts control, represented by risk management control, 300 shall apply to subjects which are applications, operating over the web, and available externally. As such, the applicability of each control to individual subjects can be predetermined based upon a structured boolean language operating upon values associated with a set of attributes.

Returning to the process 200 of FIG. 2, once the risk management controls have been created and populated, a risk management profile is created for a selected subject (stage 210). Once the risk management profile is created, a plurality of values is associated with a plurality of attributes of the profile (stage 212). The attributes define any type of property of a subject and may be predefined and/or extensible. The values of the attributes may be boolean or definite based upon the nature of the attribute. For example, a description attribute might have a textual value, which an attribute “PasswordRequired” might have values of only TRUE or FALSE. For purposes of non-limiting example, the attributes may include name, description, resource type, application architecture, developed by, owner, criticality, information stored, and exposure. In a further form, the attributes may be inherited from larger groups of profiles, such that each profile within the group inherits a predetermined set of values for selected attributes. In a still further form, the attributes may be derived or calculated, such as a security audit score, trust level, or criticality index. Once again, as above, a decision is made whether or not more subjects exist within the infrastructure of the organization for inclusion (stage 214). If additional subjects exist, the process returns to stage 210 and iterates until all of the identified subjects have associated risk management profiles defined. Once completed, the process proceeds to stage 216. It shall be appreciated that the order of creating the plurality of risk management controls and risk management profiles is not important, and in fact that new profiles and controls may be created at any time in the process.

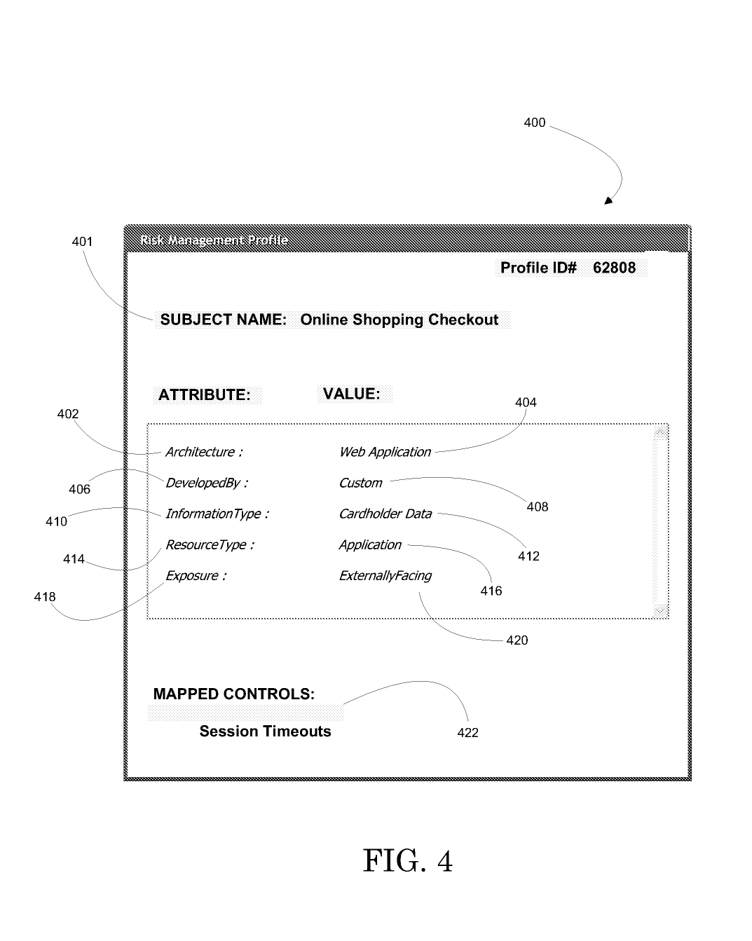

Turning briefly to FIG. 4, a plan view of a representative risk management profile, such as that associated with application 72 of FIG. 1, is illustrated according to the preferred embodiment of the present invention. Risk management profile 400 includes a subject name 401, attributes 402, 406, 410, 414, and 418 as well as values 404, 408, 412, 416, and 420 which are associated with the individual attributes respectively. As can be seen, profile 400 defines that application 72 is a web application available to external users which was developed by a custom developer and operates on at least cardholder data. Additionally, in a preferred form, risk management profile 400 may include a listing 422 of currently mapped risk management controls, which indicate the controls which should be implemented on the subject corresponding to profile 400.

Returning again to FIG. 2, the final process stage, stage 216, involves the mapping of the individual risk management controls to the individual risk management profiles based upon the criteria and values associated with them. This mapping step is performed automatically, without manual intervention, by a computer processor operating upon the risk management controls and risk management profiles stored within an electronic database. In the preferred form, the one or more boolean expressions which comprise the criteria of each risk management control operate on the value associated with the proper attribute in order to properly determine the applicability of the control the subject represented by the profile. For instance, the criteria of the risk management control 300 of FIG. 3 all evaluate to TRUE when compared to the values associated with the attributes of the risk management profile 400 of FIG. 4. As such, the control associated with the risk management control 300 would be mapped to the subject associated with the risk management profile 400. It shall be appreciated that a mapping is essentially the indication within the software platform that a specified control should be implemented on a specified subject. The process ends at end point 218, but it shall be appreciated that once completed, portions of the process, such as the creation of an addition risk management profile due to the addition of a new subject may be performed and have risk management controls mapped to it. Alternatively, new risk management controls may be added and automatically mapped to the existing risk management profiles.

The actual implementation of the control may take an affirmative step by the organization, such as programming an application so as to require password authentication, or placing a physical access restriction on the door to a secured area. In the described example, the organization would need to program a time-out feature into the application in order to comply with the mapping which indicates that the feature is needed.

In an alternate embodiment, a process utilizes a predetermined set of attributes for defining a subject within a risk management profile and a standardized set of risk management controls. Additionally, the standardized risk management controls may correspond to the individual commandments of one or more security references in a many to many relationship.

In another aspect of the present invention, a process for automatically determining a set of risk management profiles, such as those described herein, that are in scope for a risk management commandment based upon the criteria associated with a commandment and the values associated with each profile. Security references are pro forma security policies which are set forth by various entities, associations, and governmental agencies/laws. Each security reference includes a number of commandments which require compliance in order to satisfy the issuing entity. However, each commandment is not globally applicable, as it may be applicable to one server but not another, based merely upon the type of information it maintains or how it is used. If a subject is determined to require compliance with a commandment it is referred to as “in-scope” for that reference or commandment. Additionally, when an audit is performed to determine if the individual subjects of an organization are in compliance with a commandment of a security reference for reporting purposes, the organization does not want to waste time auditing subjects which are not in-scope and certainly does not want to report non-compliance for a subject when it is not in-scope. Therefore, a process for automatically determining a set of risk management profiles which correspond to a set of individual subjects which are in-scope for the commandments of a security reference provides numerous advantages.

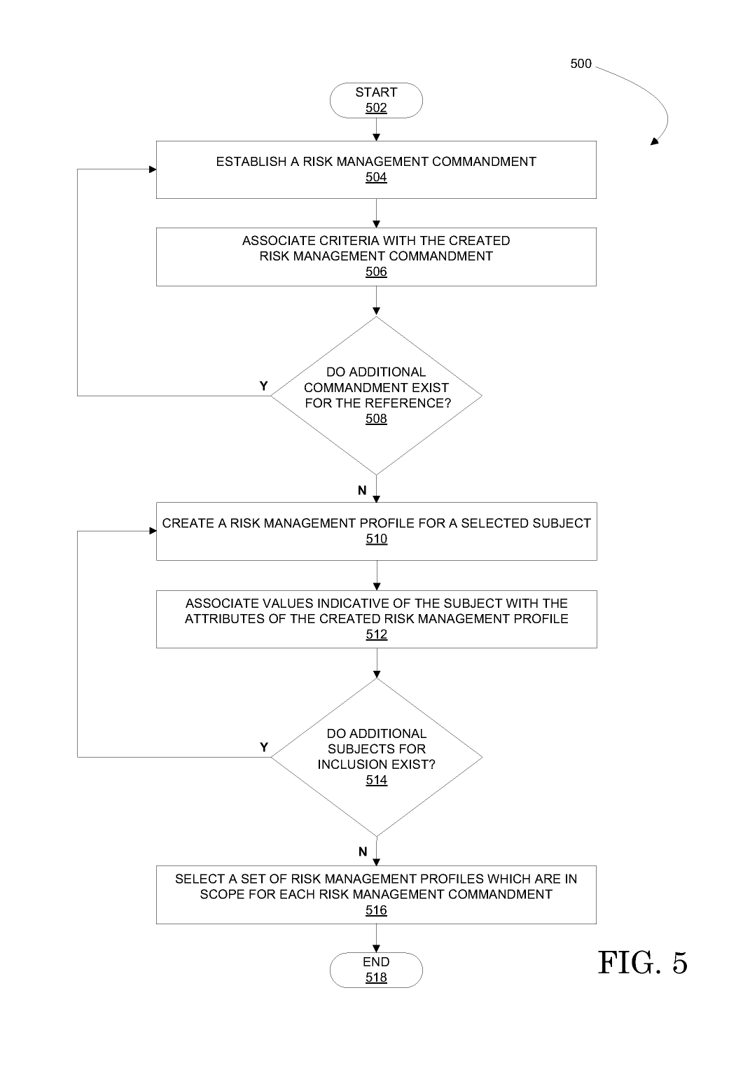

FIG. 5 is a flowchart illustrating one set of the steps performed to automatically determine a set of subjects that are in scope for the commandments of a selected security reference. The process 500 begins at start point 502 with the organization establishing a risk management commandment (stage 504). Each risk management commandment is a software representation of a commandment set forth by a security reference which may be created within a software package and stored in an electronic database. In one embodiment, the security reference may be the Sarbanes-Oxley Act, the Gramm Leach Bliley Act, the Health Insurance Portability and Accountability Act (HIPAA), or the standards sets forth by the National Institute of Standards and Technology (NIST). In yet another embodiment, the security reference may be ISO 17799, ISO 27001, ISO 27002, or the Control Objectives for Information and Related Technology (COBIT).

Once created, each risk management commandment is populated with a set of criteria (stage 506), similar to the criteria described herein with respect to a risk management control. The criteria indicate the type of subject to which the commandment should apply. For example, a commandment from PCI might only apply to web servers which send/receive credit card information in the conduct of e-business for the organization and not a user workstation in which an employee may enter the credit card information during non-work related web browsing. Once the criteria have been associated with the risk management commandment in stage 506, a decision is made whether or not more commandments exists within the security reference for inclusion (stage 508). If additional commandments exist, the process returns to stage 504 and iterates until all of the desired controls have been defined. Once completed, the process proceeds to stage 510.

The set of risk management profiles performed in steps 510-514 are similar to those described herein with reference to steps 210-214 of FIG. 2. Once the risk management profiles are defined, process 500 continues as the criteria associated with the risk management commandments are then compared to the values associated with the attributes of each risk management profile by a computer processor to select a set of risk management profiles which are in-scope for a selected risk management commandment (stage 516). The process ends at end point 518, and the selected set may then be audited for inclusion within a compliance report to the issuer of the security reference or the like.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A method comprising:
maintaining a plurality of risk management controls in an electronic database, each risk management control having at least one criterion indicating the subjects to which it should apply;
establishing a risk management profile within said electronic database, wherein said risk management profile represents a subject within an organization;
receiving a first plurality of values corresponding to a second plurality of attributes for association with said risk management profile; and
automatically mapping at least one control within said plurality of risk management controls to said risk management profile based upon said at least one criterion and said first plurality of values.

2. The method of claim 1, wherein said subject has a type selected from the group consisting of: an application, a server, a network, a database, a workstation, a business process, and a user.

3. The method of claim 1, wherein said at least one criterion comprises a boolean expression for operation on at least one of said plurality of values associated with each risk management profile.

4. The method of claim 3, wherein said boolean expression evaluates to TRUE based upon said first plurality of values when said risk management control should be applied to the subject associated with said risk management profile.

5. The method of claim 1, wherein at least a portion of said first plurality of values is received from a security consultant.

6. The method of claim 1, wherein said second plurality of attributes is predefined.

7. The method of claim 1, wherein said second plurality of attributes is extensible.

8. The method of claim 3, wherein at least one value within said first plurality of values is calculated from information pertaining to said subject.

9. The method of claim 3, wherein said first plurality of values includes at least one value corresponding to a business interest affected by said subject.

10. The method of claim 3, wherein said plurality of risk management controls includes at least one control setting forth a requirement selected from the group consisting of: password complexity, minimum encryption level, presence of a firewall, and user access restrictions.

11. The method of claim 3, wherein at least a portion of said plurality of risk management controls correspond to the requirements of a standard selected from the group consisting of the Payment Card Industry Data Security Standard (PCI), ISO 17799, ISO 27001, ISO 27002, and the Control Objectives for Information and Related Technology (COBIT).

12. The method of claim 3, wherein at least a portion of said plurality of risk management controls correspond to the requirements of a federal requirement selected from the group consisting of the Sarbanes-Oxley Act, the Gramm Leach Bliley Act, the Health Insurance Portability and Accountability Act (HIPAA), and the standards sets forth by the National Institute of Standards and Technology (NIST).

13. The method of claim 1, wherein said automatically mapping is performed without user intervention.

14. A method comprising:
maintaining at least one security reference in an electronic database, each security reference having at least one risk management commandment, said risk management commandment having at least one criterion indicating the subjects to which it should apply;
establishing a plurality of risk management profiles within said electronic database, wherein each risk management profile within said plurality represents a subject within an organization;
receiving a first plurality of values corresponding to a second plurality of attributes for association with said risk management profile; and
automatically selecting a set of risk management profiles from said plurality of risk management profiles that are in-scope for said at least one risk management commandment based on said at least one criterion and said first plurality of values.

15. The method of claim 14, wherein said set of risk management profiles includes at least one risk management profile.

16. The method of claim 14, wherein said at least one criterion comprises a boolean expression for operation on at least one of said first plurality of values associated with each risk management profile.

17. The method of claim 15, further comprising the steps of:
receiving audit information indicating the compliance of the subject associated with each risk management profile within said set with at least one associated risk management control; and
generating a report indicating the compliance status with said at least one security reference for the subject associated with each risk management profile within said set.

18. The method of claim 14, wherein said security reference is selected from the group consisting of the Payment Card Industry Data Security Standard (PCI), ISO 17799, ISO 27001, ISO 27002, and the Control Objectives for Information and Related Technology (COBIT).

19. The method of claim 14, wherein said security reference is selected from the group consisting of the Sarbanes-Oxley Act, the Gramm Leach Bliley Act, the Health Insurance Portability and Accountability Act (HIPAA), and the standards sets forth by the National Institute of Standards and Technology (NIST).

20. A method comprising:
maintaining a plurality of risk management controls in an electronic database, each risk management control having a plurality of criteria indicating the subjects to which it should apply, said plurality of criteria including at least one boolean expression;
establishing a plurality of risk management profiles within said electronic database, wherein each of said plurality of risk management profiles represents a unique subject within an organization;
receiving for each profile within said plurality of risk management profiles a plurality of values corresponding to a second plurality of predetermined attributes for association with said risk management profile; and
automatically mapping each control within said plurality of risk management controls to a subset of said plurality of risk management profiles based upon said plurality of criteria and said first plurality of values without user intervention.
